(19) United States
(12) Patent Application Publication
(10) Pub. No.: US 2007/0166099 A1
(43) Pub. Date: Jul. 19, 2007

(54) Beam-column clamp

(76) Inventors: Mark DiVito, Woodbridge (CA); John K. Cripps, Brampton (CA); Vincenzo Gentile, Toronto (CA)

Correspondence Address: BERESKIN AND PARR, 40 KING STREET WEST, BOX 401, TORONTO, ON, M5H 3Y2, CA

(21) Appl. No.: 11/639,193

(22) Filed: Dec. 15, 2006

(30) Foreign Application Priority Data
Dec. 20, 2005 (CA) 2530902

(51) Int. Cl. F16L 41/00; B25G 3/00; F16B 7/08; F16B 9/00

(52) U.S. Cl. 403/230

(57) ABSTRACT

A beam-column clamp apparatus is disclosed. The apparatus includes first and second clamping members with hook like distal portions to clamp the beam. The first and second clamping members are in opposed relation to each other. A leg projects downwardly from each clamping member. The legs are received within the first end of the column and co-operate with each other to secure the first and second clamping members to the column.

### FIELD OF THE INVENTION

This invention relates to building construction, and in particular, to a clamp for securing a beam to a column.

### BACKGROUND OF THE INVENTION

In the building construction process, it is typically necessary at some point to securely connect a beam to a column. One known beam to column connection, particularly useful for securing metal beams to metal columns, requires welding the beam to the column.

This prior art beam-column connection has numerous disadvantages. One of these disadvantages is that the use of welding equipment on construction sites creates a significant risk of fire. This in turn increases the cost of construction by increasing the cost of insurance.

Accordingly, there is a need for a beam column connection which does not require welding.

### SUMMARY OF THE INVENTION

The present invention provides an improved beam-column clamp which permits a beam to be secured to a column without welding.

According to a first aspect of the invention, an apparatus for clamping a beam to a first end of a column is provided. The apparatus comprises first and second clamping members adapted to clamp the beam. The first and second clamping members are in opposed relation to each other. A leg projects downwardly from each clamping member. The legs are received within the first end of the column and co-operate with each other to secure the first and second clamping members to the column.

According to a second aspect of the invention, an apparatus for clamping a beam to a first end of a column is provided. The apparatus comprises first and second clamping members adapted to clamp the beam. The first and second clamping members are in opposed relation to each other. Each clamping member comprises: (i) a proximate portion; (ii) a distal hook portion adapted to engage the beam; and (iii) a ridge located between the proximate portion and the distal hook portion. A leg projects downwardly from each of the clamping members and is received within the first end of the column. The legs of the clamping members cooperate with each other to secure the first and second clamping members to the column. The proximate portion and the distal hook portion of the clamping members are adapted to rotate about the ridge to clamp the beam.

According to a third aspect of the invention, an apparatus for clamping a beam to a first end of a column is provided. The apparatus comprises first and second clamping members adapted to clamp the beam. The first and second clamping members are in opposed relation to each other. Each clamping member comprises: (i) a proximate portion; (ii) a distal hook portion adapted to engage the beam; and (iii) a ridge located between the proximate portion and the distal hook portion. A leg projects downwardly from each of the clamping members and is received within the first end of the column. The legs of the clamping members cooperate with each other to secure the first and second clamping members to the column. A compression plate is located between the proximate portion of each clamping member and the leg. Upon application of force on the compression plate, the compression plate is adapted to crimp the proximate portion and the hook portion of the clamping members to securely engage the beam.

### BRIEF DESCRIPTION OF THE DRAWINGS

In the accompanying drawings:

FIGS. 1A and 1B are perspective views showing a first embodiment of the present invention;

FIG. 2 is an exploded perspective view of the first embodiment;

FIG. 3 is an elevation view of the first embodiment;

FIGS. 4A-4F show various views of the clamping member of the first embodiment;

FIG. 5 is a partial cross-sectional view of the first embodiment;

FIG. 6 is an elevation view of a second embodiment of the present invention;

FIGS. 7A-7F show various views of the clamping member of the second embodiment;

FIGS. 8A-8F show various views of a clamping member of the third embodiment;

FIG. 9A is a partial elevation view showing the clamping member of the third embodiment in the clamped position; and

FIG. 9B is a partial elevation view showing the clamping member of the third embodiment in the open position.

### DETAILED DESCRIPTION OF THE INVENTION

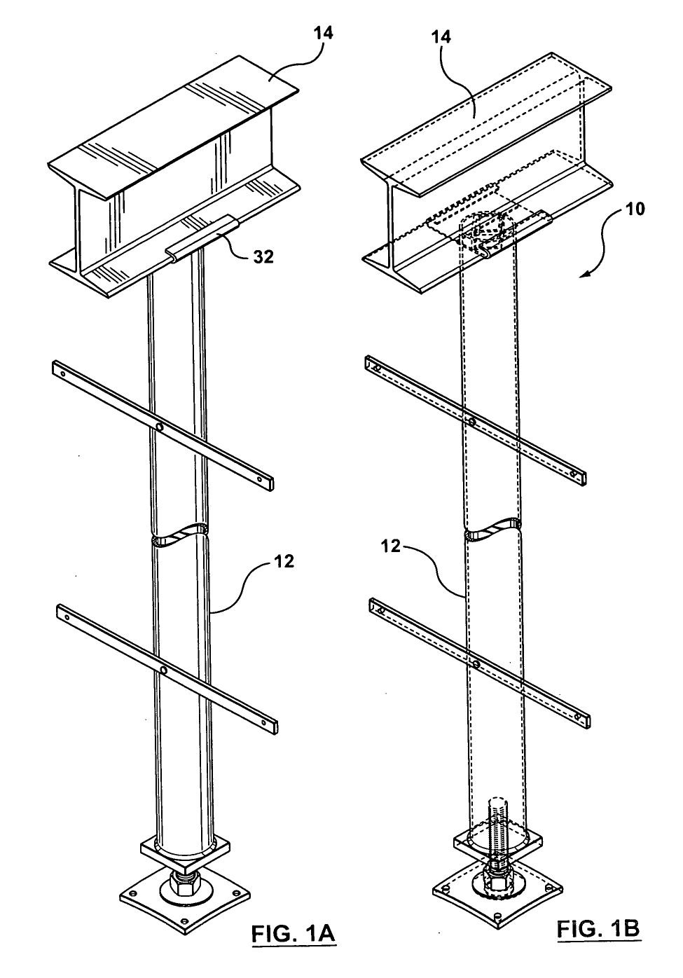

FIGS. 1A, 1B, 2, and 3 show a beam-column clamp apparatus 10 for clamping a beam 14 to a column 12 according to a first embodiment of the present invention.

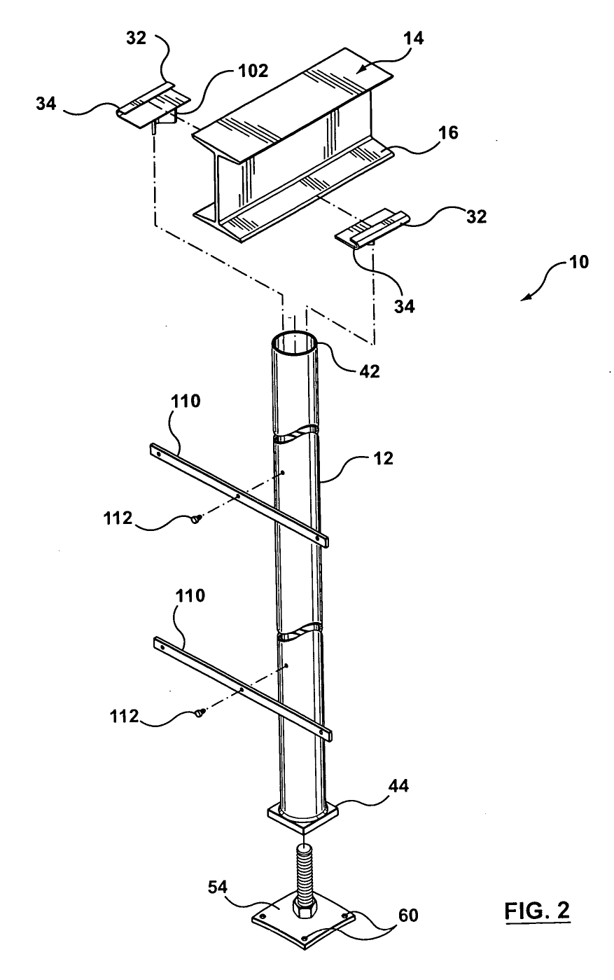

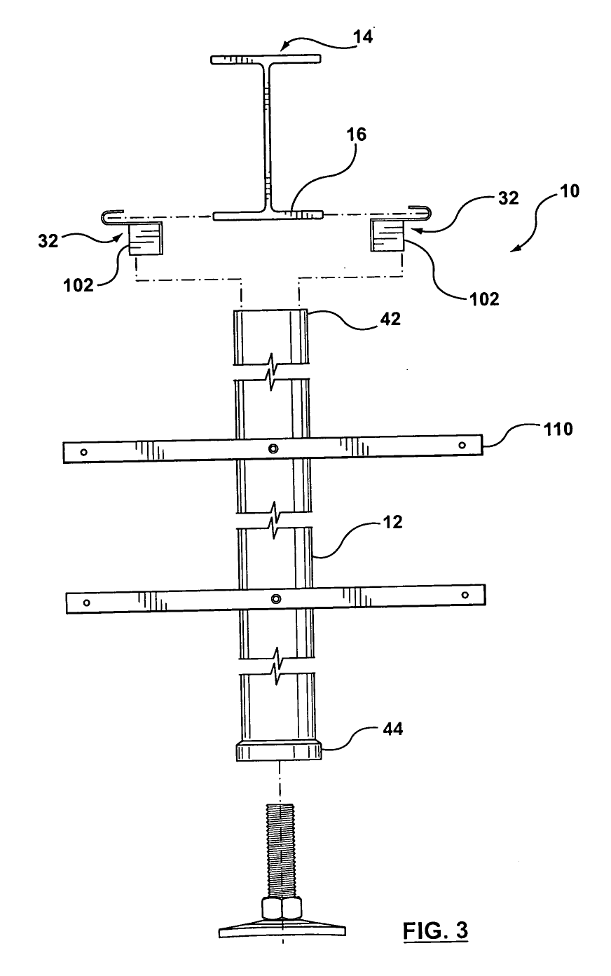

Referring now to FIGS. 2 and 3, the column 12 may have a first end, such as upper end 42, and second end, such as lower end 44. The beam-column clamp 10 is particularly suited for securing an I-beam or other beam having a flange 16 to the column 12, which preferably has a hollow cylindrical shape.

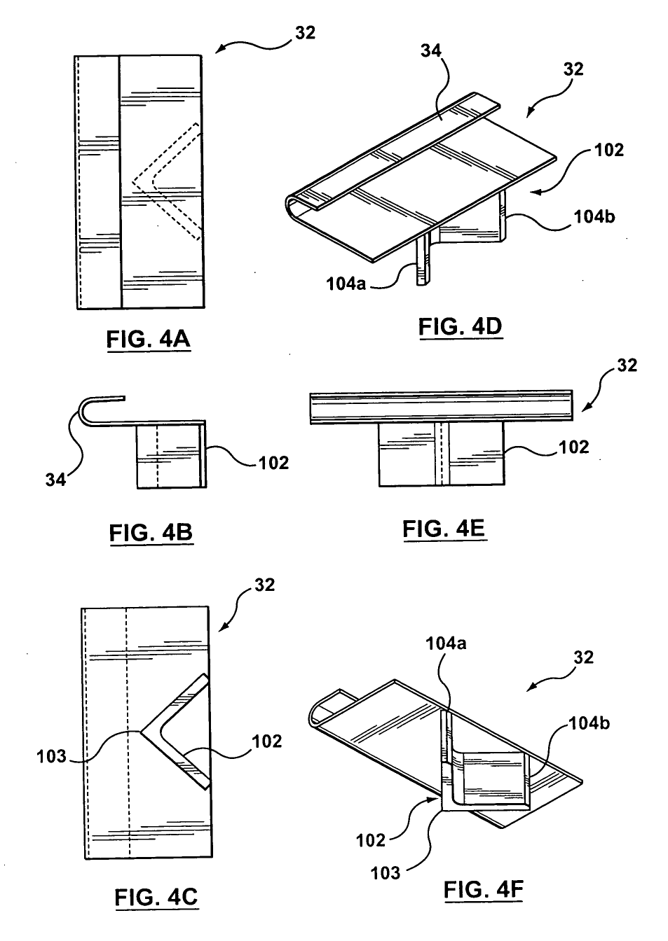

Referring to FIGS. 2 and 4A-F, the beam-column clamp apparatus 10 preferably includes a pair of identical clamping members 32. Each clamping member includes a hook-shaped distal portion 34 to securely engage the lower flange 16 of the beam 14.

Each of the clamping members 32 is connected to a leg 102. Preferably, each leg 102 is an L-shaped plate sized so that it is received within the upper end 42 of the cylindrical hollow column 12. Each leg 102 includes a corner edge 103 and a pair of distal edges 104a, 104b.

It will be understood by those skilled in the art that the dimensions of the clamping members may be sized in any suitable fashion to fit to a particular size of beam 14 or column 12. For example, for a W200×15 beam, the height of each leg 102 may be in the range of 1.5 inches, the width of each clamping member 32 may be in the range of 2.5 inches and the length may be in the range of 6 inches. The hook shaped portion 34 of each clamping member is sized appropriately to snugly fit onto the flange 16 of the beam 14.

Referring to FIG. 2, braces 110 may be secured to the column 12 using any suitable fasteners, such as a rivet 112. The braces 110 may be used to improve the stability of the column 12 by connecting it to other structural members, such as other columns.

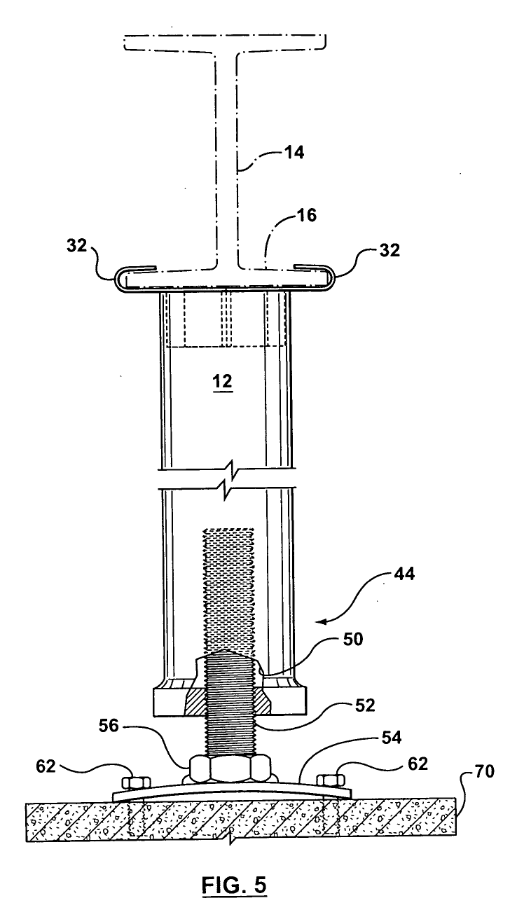

Referring now to FIGS. 2 and 5, the lower end 44 of the column 12 includes a threaded opening 50 which receives an upper end of a threaded adjustment rod 52. The lower end of the adjustment rod 52 is connected to a foot plate 54. An adjustment nut 56 is secured to the adjustment rod 52.

The foot plate 54 has a plurality of holes 60 to receive fasteners 62 to secure the foot plate 54 to a surface, such as a foundation 70. Preferably, the foot plate 54 has a curved or “dished” surface.

The operation of the first embodiment of the present invention will now be described with reference to FIGS. 2 and 5. Each clamping member 32 is positioned on opposing sides of the flange 16 of beam 14. The clamping members 32 are then pushed together such that the ends of flange 16 are received within the hook shaped portion 34 of each clamping member 32.

The column 12 is then positioned under the legs 102 such that the upper open end 42 of column 12 is aligned with the legs 102. The column 12 is raised until the legs 102 are received within the upper end 42 of column 12. The pair of L-shaped legs 102 received in the column 12 form a diamond shape (when viewed in cross-section). This diamond-shaped configuration of legs 102 provides a snug fit inside column 12, and thereby improved stability of the clamping members 32. In particular, the corner edge 103 and distal edges 104a,b of each leg 102 preferably abut against the inner circumference of column 12.

Referring now to FIG. 5, the threaded rod 52 is then turned using the nut 56 until the foot plate 54 is in contact with the foundation 70. The fasteners 62 are then used to secure the foot plate 54 to the foundation 70. As a result, the threaded rod 52 is prevented from rotating because it is secured to the foundation 70 at its lower end. The column 12 is prevented from rotating relative to the threaded rod 52, because to do so would require the column 12 to move vertically. The column 12 is prevented from moving vertically because it is secured to the beam 14 at its upper end 42 by the clamping members 32.

The pair of clamping members 32 resist movement of the upper end 42 of the column 12 relative to beam 14 by the snug fit of the hook shaped portion 34 of each clamping member 32.

Braces 110 may then be bent and nailed to adjacent studs (not shown) to provide additional stability for the column 12.

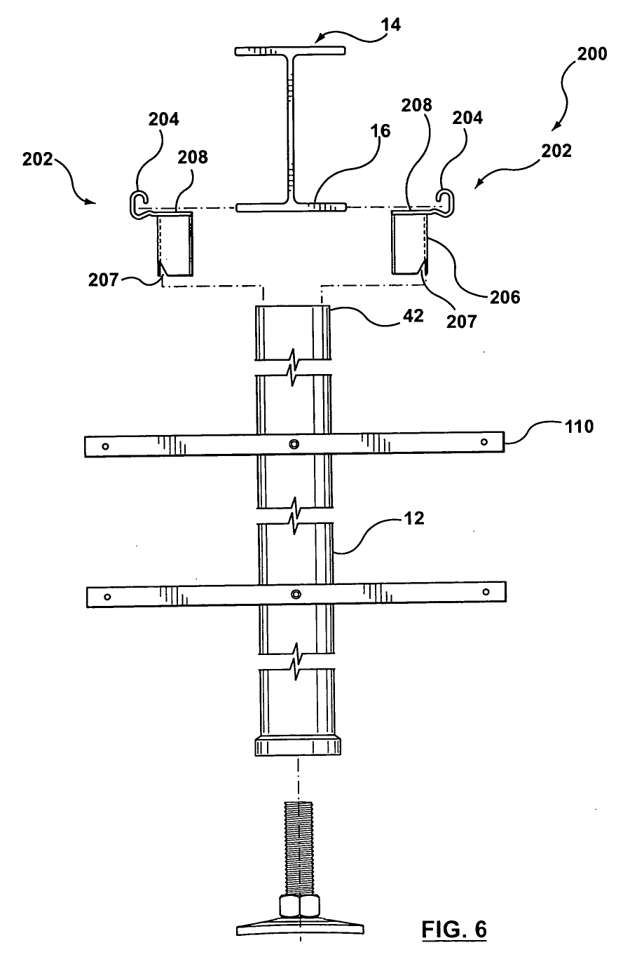

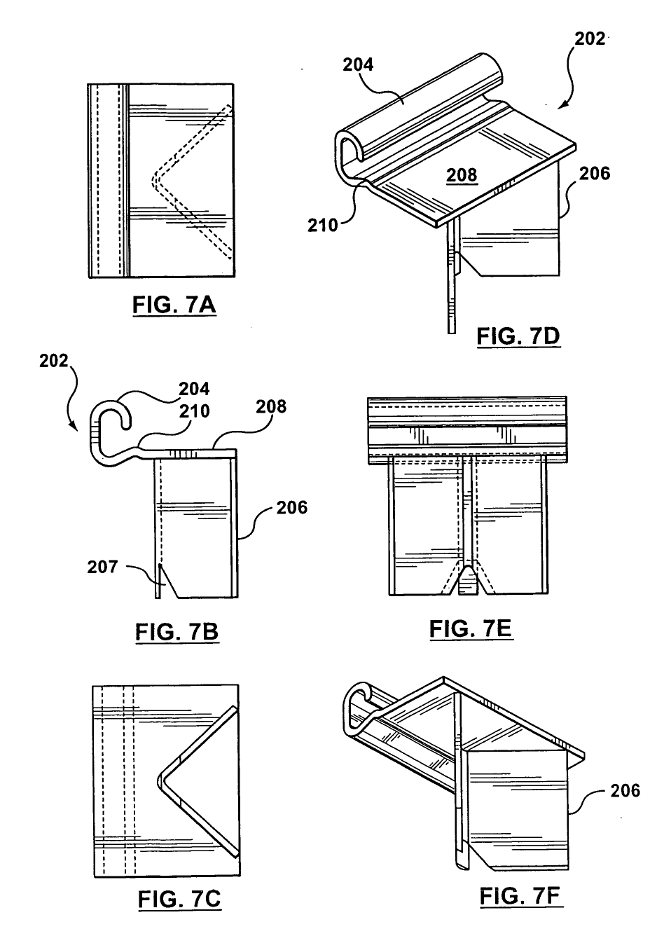

FIGS. 6 and 7A-F show a beam-column clamp apparatus 200 according to a second embodiment of the present invention. In the second embodiment, like parts have been assigned like reference numbers and will not be further described.

The beam-column clamp apparatus 200 preferably includes a pair of identical clamping members 202, each having a distal hook portion 204. A leg 206 projects downwardly from each clamping member 202. The leg 206 may include cutouts 207 for ease of entry of the leg 206 into the column 12. The cutouts 207 may be desirable due to the increased leg length of this embodiment. Preferably, the length of leg 206 is about 3 inches, which compares with the preferred leg length of about 1.5 inches for the first embodiment.

As best shown in FIG. 7D, each clamping member 202 includes a proximate portion 208 separated from the hook portion 204 by a ridge 210.

The operation of the second embodiment of the present invention will now be described with reference to FIGS. 6 and 7A-F. The beam column clamp apparatus 200 is installed in a manner similar to that described for the first embodiment above. As the column 12 is raised, its upper end 42 abuts against the proximate portion 208 of each clamping member 202 and exerts an upward force on the proximate portion 208. The cutouts 207 in legs facilitate the entry of legs 206 into the upper end 42 of the column 12, particularly when the legs 206 and column are not precisely aligned.

The upward force of the column 12 causes the proximate portion 208 to rotate about the ridge 210 toward the flange 16, such that ridge 210 acts as a fulcrum. The hook portion 204 also rotates about ridge 210. The rotation of the hook portion 204 of each clamping member 202 causes it to press downward onto the flange 16 of the beam 14 to secure the clamping member 202 (as best shown in FIG. 5).

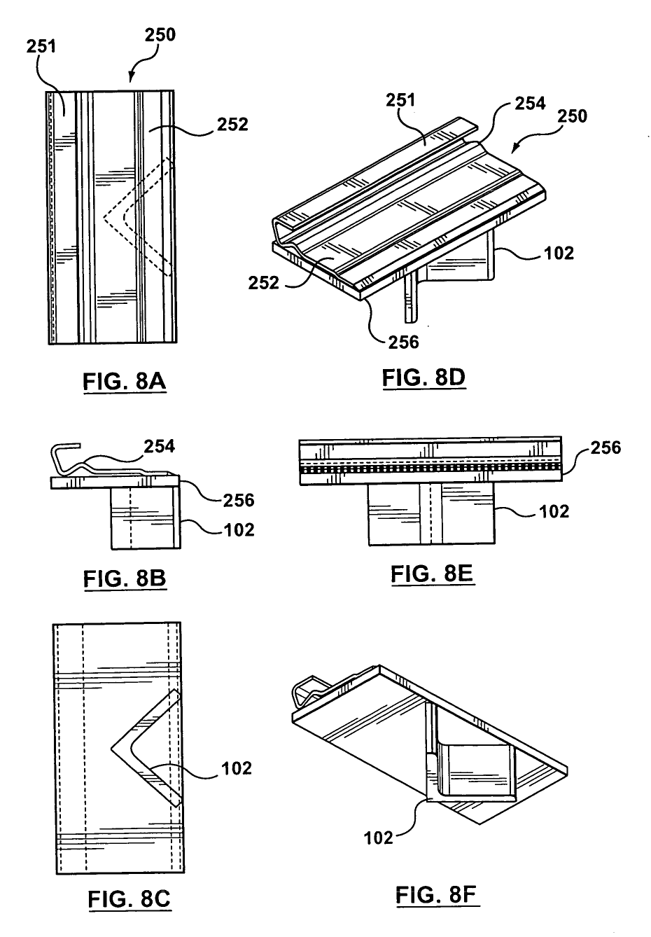

FIGS. 8A-F and 9A-B show a clamping member 250 for a beam-column clamp apparatus according to a third embodiment of the present invention. In the third embodiment, like parts have been assigned like reference numbers and will not be further described. Each clamping member 250 includes a proximate portion 252 separated from a distal hook portion 251 by a ridge 254. A compression plate 256 is positioned between the leg 102 and the clamping member 250.

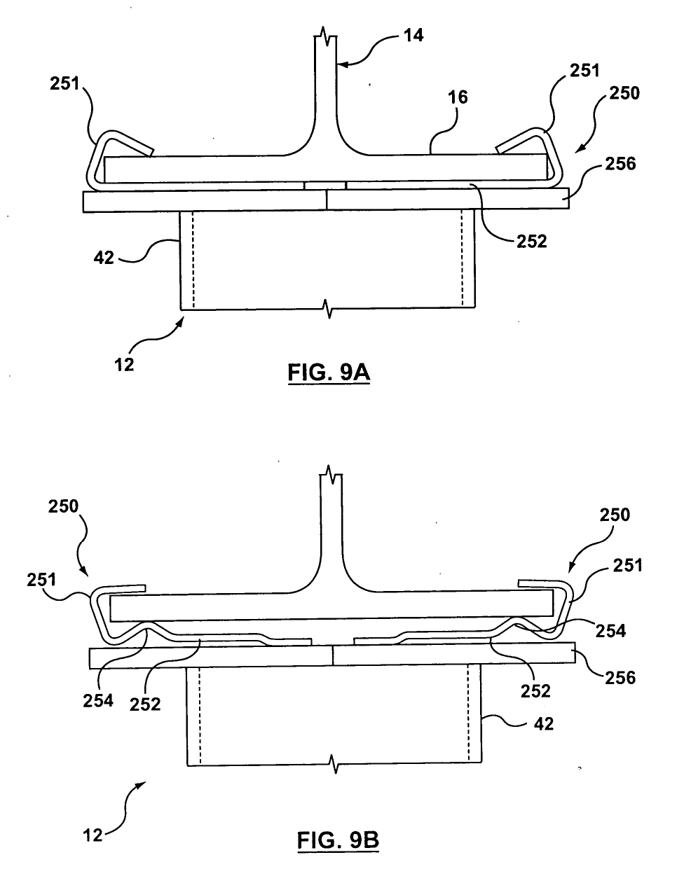

As best shown in FIGS. 9A and 9B, during operation, the upper end 42 of the column 12 exerts an upward force on the compression plate 256, thereby crimping the distal hook portion 251, and proximate portion 252 of each clamping member 250 between the compression plate 256 and the flange 16, thereby causing the hook portion 251 to securely engage the flange 16.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. An apparatus for clamping a beam to a first end of a column, the column having a second end securable to a surface, the apparatus comprising:
a) a first clamping member and a second clamping member, wherein the first clamping member is in opposed relation to the second clamping member, wherein the first and second clamping members are adapted to clamp the beam;
b) a leg projecting downwardly from each of the clamping members, wherein the leg is received within the first end of the column, wherein the leg of the first clamping member cooperates with the leg of the second clamping member to secure the first and second clamping members to the column.

2. The apparatus of claim 1, wherein the leg is L-shaped.

3. The apparatus of claim 2, wherein the leg defines a corner edge and a pair of distal edges, wherein the corner edge and the pair of distal edges abut against an inner circumference of the column.

4. The apparatus of claim 3, wherein the leg of the first clamping member and the leg of the second clamping member form a diamond shape in cross-section when received in the column.

5. The apparatus of claim 4, wherein the first and second clamping members each comprise a distal hook portion adapted to grip a flange of the beam.

6. The apparatus of claim 5, wherein the second end of the column defines a threaded opening.

7. The apparatus of claim 6, further comprising:
a) a threaded rod received in the threaded opening; and
b) a foot plate connected to a lower end of the threaded rod, wherein the foot plate is adapted for being secured to the surface;
wherein the threaded rod is rotatable to bring the foot plate in contact with the surface.

8. The apparatus of claim 7, further comprising a nut secured to the threaded rod, wherein the threaded rod is rotated by turning the nut.

9. An apparatus for clamping a beam to a first end of a column, the column having a second end securable to a surface, the apparatus comprising:
a) a first clamping member and a second clamping member, wherein the first clamping member is in opposed relation to the second clamping member, wherein the first and second clamping members are adapted to clamp the beam; each of the first and second clamping members comprising:
i) a proximate portion;
ii) a distal hook portion adapted to engage the beam;
iii) a ridge located between the proximate portion and the distal hook portion; and
b) a leg projecting downwardly from each of the clamping members, wherein the leg is received within the first end of the column, wherein the leg of the first clamping member cooperates with the leg of the second clamping member to secure the first and second clamping members to the column;
wherein the proximate portion and the distal hook portion are adapted to rotate about the ridge to clamp the beam.

10. The apparatus of claim 9, wherein the ridge comprises an upwardly raised edge running between the proximate portion and the distal hook portion.

11. The apparatus of claim 10, wherein the proximate portion of the first and second clamping members is adapted to receive an upward force from the upper end of the column.

12. The apparatus of claim 11, wherein the leg is L-shaped.

13. The apparatus of claim 12, wherein the leg defines a corner edge and a pair of distal edges, wherein the corner edge and the pair of distal edges abut against an inner circumference of the column.

14. The apparatus of claim 13, wherein the leg defines a cutout therein.

15. The apparatus of claim 14, further comprising:
a) a threaded rod received in the threaded opening; and
b) a foot plate connected to a lower end of the threaded rod, wherein the foot plate is adapted for being secured to the surface;
wherein the threaded rod is rotatable to bring the foot plate in contact with the surface.

16. The apparatus of claim 15, further comprising a nut secured to the threaded rod, wherein the threaded rod is rotated by turning the nut.

17. An apparatus for clamping a beam to a first end of a column, the column having a second end securable to a surface, the apparatus comprising:
a) a first clamping member and a second clamping member, wherein the first clamping member is in opposed relation to the second clamping member, wherein the first and second clamping members are adapted to clamp the beam; each of the first and second clamping members comprising:
i) a proximate portion;
ii) a distal hook portion adapted to engage the beam;
iii) a ridge located between the proximate portion and the distal hook portion; and
b) a leg projecting downwardly from each of the clamping members, wherein the leg is received within the first end of the column, wherein the leg of the first clamping member cooperates with the leg of the second clamping member to secure the first and second clamping members to the column;
c) a compression plate located between the proximate portion and the leg;
wherein, upon the application of a force on the compression plate, the compression plate is adapted to crimp the proximate portion and the distal hook portion to securely engage the beam.

18. The apparatus of claim 17, wherein the ridge comprises an upwardly raised edge running between the proximate portion and the distal hook portion.

19. The apparatus of claim 18, wherein the leg is L-shaped.

20. The apparatus of claim 19, wherein the leg defines a corner edge and a pair of distal edges, wherein the corner edge and the pair of distal edges abut against an inner circumference of the column.

21. The apparatus of claim 20, wherein the leg of the first clamping member and the leg of the second clamping member form a diamond shape in cross-section when received in the column.

22. The apparatus of claim 21, further comprising:
a) a threaded rod received in the threaded opening; and
b) a foot plate connected to a lower end of the threaded rod, wherein the foot plate is adapted for being secured to the surface;
wherein the threaded rod is rotatable to bring the foot plate in contact with the surface.

23. The apparatus of claim 22, further comprising a nut secured to the threaded rod, wherein the threaded rod is rotated by turning the nut.
